(19) United States
(12) Patent Application Publication
(10) Pub. No.: US 2011/0210803 A1
(43) Pub. Date: Sep. 1, 2011

(54) DIFFERENTIAL CIRCUIT AND LAYOUT METHOD FOR THE SAME

(75) Inventor: GUANG-FENG OU, Shenzhen City (CN)

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/817,193

(22) Filed: Jun. 17, 2010

(30) Foreign Application Priority Data
Feb. 26, 2010 (CN) 201010114963.6

(51) Int. Cl. H01P 3/02

(52) U.S. Cl. 333/4

(57) ABSTRACT

A differential circuit includes a chip with two terminals in two directions, a first differential signal trace, and a second differential signal trace. The first differential signal trace includes a first parallel section and a first unparallel section connecting the first parallel section to a terminal of the chip. The second differential signal trace includes a second parallel section parallel to the first parallel section, a second unparallel section connecting to the second parallel section, and an equalizing section connecting second unparallel section to the another terminal of the chip. The second parallel section is equal to the first parallel section. The total length of the second unparallel section and the equalizing section is equal to the length of the first unparallel section.

### BACKGROUND

1. Technical Field

The present disclosure relates to differential circuits, and particularly to a differential circuit and layout method for the differential circuit.

2. Description of Related Art

A differential pair is a pair of signal traces. The differential pair is capable of transmitting two equivalent but inverted differential signals synchronously. That will improve transmission characteristics of the signals.

With the further development of electronic products, the performance of chips incorporated in the electronic products are enhanced further, and the number of I/O (input/output) connections of such a chip has increased. The increasing number of the I/O connections requires bond pads of the chip to be arranged in multiple directions, so that all the I/O connections can be placed. The differential signal traces of a pair are generally parallel to each other except when the traces approach and connect to two bond pads in two directions.

Referring to FIG. 2, a printed circuit board 1 with a conventional differential circuit 10 on it is shown. The differential circuit 10 includes a differential pair 300 connected to a first chip 200. The first chip 200 includes a first terminal 210 and a second terminal 220 arranged at different sides of the first chip 200. The differential pair 300 includes a first differential signal trace 310 connected to the first terminal 210 and a second differential signal trace 320 connected to the second terminal 220. The total length of the first differential signal trace 310 is equal to that of the second differential signal trace 320.

The first differential signal trace 310 includes a first parallel section 311 and a first unparallel section 312. The first parallel section 311 includes a first bent portion 311a. The first unparallel section 312 connects the first parallel section 311 to the first terminal 210. The second differential signal trace 320 includes a second parallel section 321 and a second unparallel section 322. The second parallel section 321 is parallel and corresponds to the first parallel section 311, and the second unparallel section 322 is unparallel and corresponds to the first unparallel section 312. The second parallel section 321 includes a second bent portion 321a. The second unparallel section 322 connects the second parallel section 321 to the second terminal 220. The first unparallel section 312 is longer than the second unparallel section 322 which results two synchronous differential signals to become asynchronous when the signal pair passes the first unparallel section 312 and the second unparallel section 322. And the differential signals in the first parallel section 311 and the second parallel section 321 are asynchronous. But the differential signals leave the first differential signal trace 310 and the second differential signal trace 320 simultaneously because the total length of the first differential signal trace 310 is the same as that of the second differential signal trace 320. Furthermore, the radius of curvature of the first bent portion 311a is bigger than that of the second bent portion 321a, which also affects the synchronization of the signal pair pasting the first bent portion 311 a and the second bent portion 321a.

With the increase in the signal frequency, the asynchronous problem of the differential signals in the unparallel sections and the parallel sections will be more obvious. Furthermore, the asynchronous problem of the differential signals reduces their noise immunity.

What is needed, therefore, is a differential circuit and layout method for the same to overcome the above-described problem.

### BRIEF DESCRIPTION OF THE DRAWINGS

Many aspects of the differential circuit and layout method for the same can be better understood with reference to the following drawings. The components in the drawings are not necessarily drawn to scale, the emphasis instead being placed upon clearly illustrating the principles of the differential circuit and layout method for the same.

FIG. 1 is a schematic view of a printed circuit board with a differential circuit on it, according to an exemplary embodiment.

FIG. 2 is a schematic view of a printed circuit board with a conventional differential circuit on it.

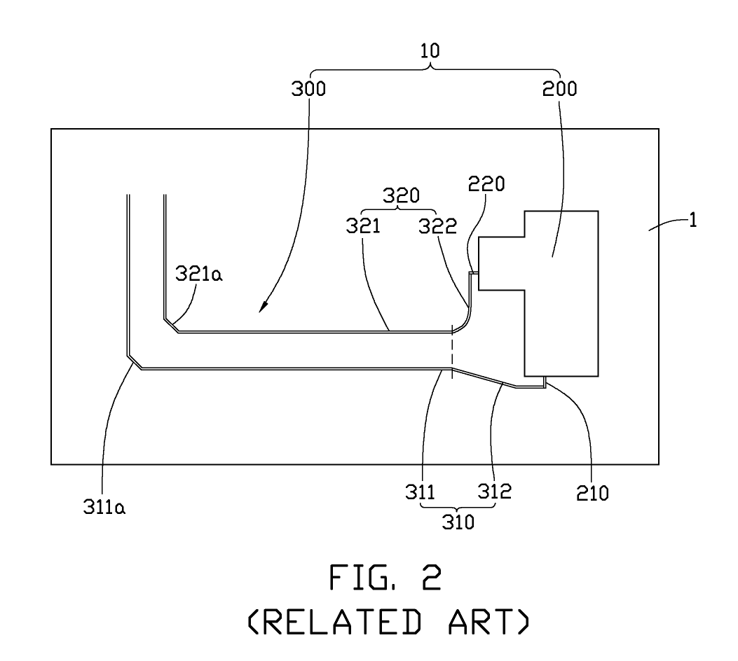

### DETAILED DESCRIPTION

Embodiments of the present disclosure will now be described in detail below, with reference to the accompanying drawings.

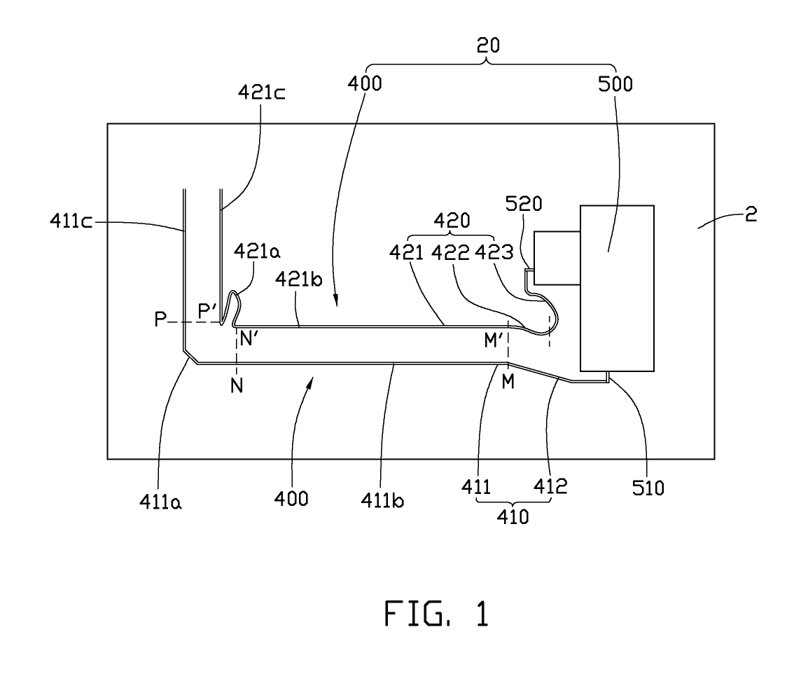

Referring to FIG. 1, a print circuit board 2 with a differential circuit 20 according to an exemplary embodiment is shown. The differential circuit 20 includes a differential pair 400 connected to a second chip 500. The second chip 500 is a duplication of the first chip 200. The second chip 500 includes a third terminal 510 and a fourth terminal 520. The differential pair 400 includes a third differential signal trace 410 which is a duplication of the first differential signal trace 310 and an inventive fourth differential signal trace 420 which is an improvement over the second differential signal trace 320. The third differential signal trace 410 includes a third parallel section 411 with a third bent portion 411a and a third unparallel section 412. The fourth differential signal trace 420 includes a fourth parallel section 421 having a fourth bent portion 421a, a fourth unparallel section 422 and an equalizing section 423 connected to the fourth unparallel section 422. The fourth parallel section 421 has a length equal to the third parallel section 411. The total length of the equalizing section 423 and the fourth unparallel section 422 is equal to the length of the third unparallel section 412, so that two differential signals from the second chip 500 are capable of arriving at the third parallel section 411 and the fourth parallel section 421 synchronously. In another embodiment the second chip 500 is a semiconductor package, the third terminal 510 and the fourth terminal 520 each are connected to the second chip 500 through a packaged lead in the second chip 500. The total length of the equalizing section 423, the fourth unparallel section 422 and the packaged lead connected to the fourth terminal 520 is equal to the total length of the third unparallel section 412 and the packaged lead connected to the third terminal 510. The fourth parallel section 421 is equal to the third parallel section 411.

The length of the fourth bent portion 421a is equal to the length of the third bent portion 411a, to synchronize the differential signals pasting the third bent portion 411a and the fourth bent portion 421a. In the present embodiment, the fourth bent portion 421 a is bent to a finger-shaped bend to make the length of the fourth bent portion 421a equal that of the third bent portion 411a.

A method to lay out the differential circuit 400 on the board 2 includes the following steps.

The third unparallel section 412 and the third parallel section 411 of the third differential signal trace 410 are arranged on the printed circuit board 2. In the present embodiment, the third parallel section 411 includes the third bent section 411a, a first sub-section 411b and a second sub-section 411c. The third bent portion 411a is connected between the first sub-section 411b and the second sub-section 411c. The first sub-section 411b connects to the third unparallel section 412 at point M and connects to the third bent portion 411a at point N. The second sub-section 411c connects to the third bent portion 411 a at point P.

The fourth unparallel section 422 and the equalizing section 423 are connected to the fourth unparallel section 422 are laid in series between a point M′ and the fourth terminal 520. The point M′ is spaced by a pre-determined distance from point M. The pre-determined distance is the interval between the third differential signal trace 410 and the fourth differential signal trace 420. The equalizing section 423 is connected between the fourth unparallel section 422 and the fourth terminal 520.

The length of the third unparallel section 412 and the total length of the fourth unparallel section 422 and the equalizing section 423 are measured.

The length of the equalizing section 423 is modified so that total length of the fourth unparallel section 422 and the equalizing section 423 is equal to the length of the third unparallel section 412. That is, the layout of the fourth unparallel section 422 and the equalizing section 423 are modified to ensure the section length between point M′ and the fourth terminal 520 is equal to the length of the third unparallel section 412. In an alternative embodiment, where the second chip 500 is a semiconductor package, the layout of the equalizing section 423 are modified so that total length of the fourth unparallel section 422, the equalizing section 423, and the packaged lead in the second chip 500 connected to the fourth terminal 520 is equal to the length of the third unparallel section 412 and the packaged lead in the second chip 500 connected to the third terminal 510.

The fourth parallel section 421 is laid out on the printed circuit board 2 parallel to the third parallel section 411. In the present embodiment, the fourth parallel section 421 includes the fourth bent portion 421a, a third sub-section 421b, and a fourth sub-section 421c. The fourth bent portion 421a is connected between the third sub-section 421b and the fourth sub-section 421c. This step further includes the following steps.

The third sub-section 421b is firstly laid out on the printed circuit board 100 parallel to the first sub-section 411b. In the present embodiment, the third sub-section 421b is connected to the fourth unparallel section 422 at point M′. Then, the length of the third sub-section 421b and the length of the first sub-section 411b are measured.

After measuring, the length of the third sub-section 421b is modified to equal the length of the first sub-section 411b. That makes the differential signals transmitted in the third sub-section 421b and the first sub-section 411b synchronously.

The fourth bent portion 421a is firstly laid out on the printed circuit board 100 corresponding to the third bent portion 411a. In the present embodiment, the fourth bent portion 421a is connected to the third sub-section 421b at point N′. Then, the length of the fourth bent portion 421a and the length of the third bent portion 411a are measured. After measuring, the length of the fourth bent portion 421a is modified to equal the length of the third bent portion 411a. That makes the differential signals past the fourth bent portion 421a and the third bent portion 411a synchronously. In the present embodiment, the fourth bent portion 421a is bent to a finger-shaped bend to make the length of the fourth bent portion 421a equal that of the third bent portion 411a.

The fourth sub-section 421c is firstly laid out on the printed circuit board 100 parallel to the second sub-section 411c. In the present embodiment, the fourth sub-section 421c is connected to the fourth bent portion 421a at point P′. Then, the length of the fourth sub-section 421c and the length of the second sub-section 411c are measured. After measuring, the length of the fourth sub-section 421c is modified to equal the length of the second sub-section 411c. That makes the differential signals transmitted in the fourth sub-section 421c and the second sub-section 411c synchronously.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A differential circuit comprising:
a chip comprising two terminals in two directions;
a first differential signal trace comprising a first parallel section and a first unparallel section connecting the first parallel section to one of the terminals of the chip;
a second differential signal trace comprising:
a second parallel section parallel to the first parallel section, and having a length equal to the first parallel section;
a second unparallel section connecting to the second parallel section;
an equalizing section connecting second unparallel section to the other one of the terminals of the chip, the total length of the second unparallel section and the equalizing section being equal to the length of the first unparallel section.

2. The differential circuit as claimed in claim 1, wherein the first parallel section comprise a first bent portion, the second parallel section comprise a second bent portion, and the length of the first bent portion is equal to that of the second bent portion.

3. The differential circuit as claimed in claim 2, wherein the radius of curvature of the first bent portion is bigger than that of the second bent portion bent portion, the second bent portion is bent to a finger-shaped bend to make the length of the second bent portion equal that of the first bent portion.

4. A differential circuit comprising:
a semiconductor package comprising two terminals connecting to the semiconductor package through two packaged leads in the semiconductor package;
a first differential signal trace comprising a first parallel section and a first unparallel section connecting the first parallel section to a terminal of the semiconductor package;
a second differential signal trace comprising:
a second parallel section parallel to the first parallel section, and having a length equal to the first parallel section;
a second unparallel section connecting to the second parallel section;
an equalizing section connecting second unparallel section to the another terminal of the semiconductor package, the total length of the equalizing section, the first unparallel section and the packaged lead connected to the corresponding terminal being equal to the total length of second unparallel section and the packaged lead connected to the another corresponding terminal.

5. The differential circuit as claimed in claim 4, wherein the first parallel section comprise a first bent portion, the second parallel section comprise a second bent portion, and the length of the first bent portion is equal to that of the second bent portion.

6. The differential circuit as claimed in claim 5, wherein the radius of curvature of the first bent portion is bigger than that of the second bent portion bent portion, the second bent portion is bent to a finger-shaped bend to make the length of the second bent portion equal that of the first bent portion.

7. A layout method for a differential circuit, comprising:
laying out a first differential signal trace on a circuit board with an electronic element, the first differential signal trace comprising a first parallel section and a first unparallel section connected the first parallel section to the electronic element;
laying out a second unparallel section and an equalizing section of a second signal trace on the circuit board, and the equalizing section connecting to the electronic element to the second unparallel section;
measuring the length of the first unparallel section and a total length of the second unparallel section and the equalizing section of the second differential signal trace;
modifying the length of the equalizing section to make the total length of the second unparallel section and the equalizing section equal the length of the first unparallel section;
laying out a second parallel section of the second differential signal trace on the circuit board parallel to the first parallel section, and the second parallel section connected to the second unparallel section;
measuring the length of the first parallel section and the length of the second parallel section of the second differential signal trace;
modifying the length of the second parallel section equal to the length of the first parallel section.

8. The layout method for a differential circuit as claimed in claim 7, wherein the first parallel section comprises a first sub-section, a first bent portion, and a second sub-section sequentially, the second parallel section comprises a third sub-section, a fourth sub-section, and a second bent portion correspondingly, the radius of curvature of the first bent portion is bigger than that of the second bent portion, the layout method for the differential circuit in the step of arranging the parallel section of each signal trace further comprises following steps:
laying out the third sub-section on the printed circuit board parallel to the first sub-section;
measuring the length of the third sub-section and the length of the first sub-section;
modifying the length of the third sub-section to equal the length of the first sub-section;
laying out the fourth bent portion on the printed circuit board corresponding to the third bent portion;
measuring the length of the first bent portion and the length of the second bent portion;
modifying the lengths of the second bent portion to equal the first bent portion;
laying out the fourth sub-section on the printed circuit board parallel to the second sub-section;
measuring the length of the fourth sub-section and the length of the second sub-section;
modifying the length of the fourth sub-section equal to the length of the second sub-section.

9. The layout method for a differential circuit as claimed in claim 8, wherein the second bent portion is bent to a finger-shaped bend to make the length of the second bent portion equal that of the first bent portion.

10. The layout method for a differential circuit as claimed in claim 7, wherein the electronic element is a semiconductor package.

11. The layout method for a differential circuit as claimed in claim 10, wherein the layout method for a differential circuit further comprise:
measuring the total length of the first unparallel section and the packaged lead connected to the first unparallel section in the electronic element, the total length of the second unparallel section, the equalizing section, and the packaged lead connected to the equalizing section in the electronic element;
modifying the length of the equalizing section to make the total length of the second unparallel section, the equalizing section and the corresponding packaged lead connected to the equalizing section equal the total length of the first unparallel section and the corresponding packaged lead connected to the first unparallel section.
